(19) United States
(12) Patent Application Publication
(10) Pub. No.: US 2026/0061659 A1
(43) Pub. Date: Mar. 5, 2026

(54) Combination Splitter and Grapple Technology

(71) Applicant: US Pride Products, LLC, Hammond, WI (US)

(72) Inventor: Charles VAN DUSARTZ, Hammond, WI (US)

(21) Appl. No.: 18/732,449

(22) Filed: Jun. 3, 2024

(51) Int. Cl. B27L 7/04

(52) U.S. Cl. CPC B27L 7/04

(57) ABSTRACT

A combination splitter and grapple for engaging, holding and transporting a log or group of logs or other material, and for splitting or otherwise breaking the log(s) into smaller pieces. The combination grapple and splitter is useful for processing firewood, tree services, mulch yards, land clearing, wood fuel processing, biomass, or other purposes.

### NOTICE OF COPYRIGHTS AND TRADE DRESS 37 C.F.R. § 1.71(E) AUTHORIZATION

A portion of the disclosure of this patent document may contain material which is subject to copyright protection, or which has become trade dress. The copyright and trade dress owner has no objection to the facsimile reproduction by anyone of the patent document or the patent disclosure, as it appears in the US Patent and Trademark Office patent file or records, but otherwise reserves all copyright and trade dress rights whatsoever.

### CROSS-REFERENCE TO RELATED APPLICATIONS, IF ANY

If an Application Data Sheet(s) (ADS) has been filed in this application, it is incorporated by reference herein. Any applications claimed in an ADS for priority under 35 USC 119, 120, 121 or 365, and any and all parent, grandparent, great-grandparent, etc. applications of such applications, are also incorporated by reference, including any priority claims made in those applications and any material incorporated by reference, to the extent such subject matter is not inconsistent herewith.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to materials handling systems, apparatus and methods. Particularly, the invention relates to forestry and logging systems. Most particularly, the invention relates to a combination splitter and grapple.

### 2. Background Information

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides a combination splitter and grapple apparatus, method, method of manufacture and method of use which are practical, reliable, safe and efficient, and which are believed to fulfill a need and to constitute an improvement over the background technology.

In one embodiment of the invention, a combination splitter and grapple provided for engaging, holding and transporting a log or group of logs or other material, and for splitting or otherwise breaking the log(s) into smaller pieces. The combination splitter and grapple is useful for processing firewood, tree services, mulch yards, land clearing, wood fuel processing, biomass, or other purposes.

The apparatus of the invention includes a unique electro-valve manifold assembly that adapts the relatively high hydraulic pressure and flow utilized by the splitter to a lower pressure and flow utilized by the grapple.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 shows an embodiment of a grapple-splitter apparatus of the present invention wherein an embodiment of the grapple is closed in a home position with an embodiment of the splitter pointing towards an excavator to which the apparatus is operatively coupled, the view being from the side of the apparatus.

FIG. 2 shows the apparatus with the grapple closed in a home position with the splitter pointing away from the excavator.

FIG. 3 shows the apparatus with the grapple open and the splitter is pointing towards the excavator, the view being in line with the excavator arm.

FIG. 4 shows the apparatus with the grapple open and about to engage a log, the splitter pointing away from the excavator, the view being from the side of the apparatus.

FIG. 5 shows the apparatus wherein the grapple has grasped and lifted the log in the process of moving the log.

FIG. 6 shows the apparatus wherein the grapple is closed and the splitter is in the process of engaging a log.

FIGS. 7 A/B is a diagrammatic illustration of an embodiment of the apparatus.

FIG. 8 is a schematic diagram of an embodiment of a circuit that controls an embodiment of a hydraulic electro-valve, showing the functionality and connectivity between electrical components thereof.

FIG. 9 shows an alternative embodiment of a combination splitter assembly and pickup assembly. The combination apparatus utilizes an existing excavator thumb in place of a grapple.

### DETAILED DESCRIPTION

The description that follows describes, illustrates and exemplifies one or more embodiments of a grapple-splitter apparatus and system. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

A grapple, in general, is a hook or claw that is used to hold something. In forestry and the logging industry, a grapple is an engineered tool to gather, grasp, hold and move logs or other material that is typically mounted on or with a vehicle for locomotion to a work site. The grapple is typically hydraulically powered and has a claw assembly with two more opposing levers that pinch a log, a group of logs, or other materials, usually to lift or drag them. A grapple can also be powered and controlled by cables or motors. The grapple can be mounted on a tractor or excavator and may have a moveable arm that may lift, extend/retract, and move side to side, with pivot or rotation Some assemblies may also have a separate control for rotating the grapple at the end of the arm.

Splitters are devices that split logs for firewood, tree services, mulch yards, land clearing, wood fuel processing, biomass, or other purposes. One type of splitter utilizes a cone, screw, auger, or cone-screw to split large logs, quickly, safely and efficiently. Cone splitters may be connected to vehicles such as a tractor, skid steer, or excavator. Exemplary cones splitters are manufactured and distributed by Applicant's assignee, U.S. Pride Products of Hammond, Wisconsin USA.

The apparatus and systems of the present invention combine a grapple with a cone splitter. A combination grapple and splitter is used for engaging, holding and transporting a log or group of logs or other material, and for splitting or otherwise breaking the log(s) into smaller pieces. The combination grapple and splitter is useful for processing firewood, tree services, mulch yards, land clearing, wood fuel processing, biomass, or other purposes.

In one embodiment the invention is a cone splitter with grapple attachment for improved splitting productivity. One excavator and operator can handle splitting and staging of split material without leaving the cab of an excavator (or tractor, skid steer, or other vehicle). Excavators have typically been the most productive splitters because of their power, reach and maneuverability. This splitter/grapple package of the present invention may be assembled new or constructed as retrofit kit for existing splitters. In the preferred embodiment, the splitter is an auger cone splitter, such as the two speed HF-800 splitter manufactured and distributed by U. S. Pride Products. Such splitter is described in U.S. Pat. No. 7,814,946, which is incorporated by reference herein for all purposes. An exemplary grapple assembly is a Fixed Rotating Bypass Grapple, Model 2951, 59, 70, or 78 manufactured and distributed by Ryan's Equipment, Inc. of Edmore, Michigan USA.

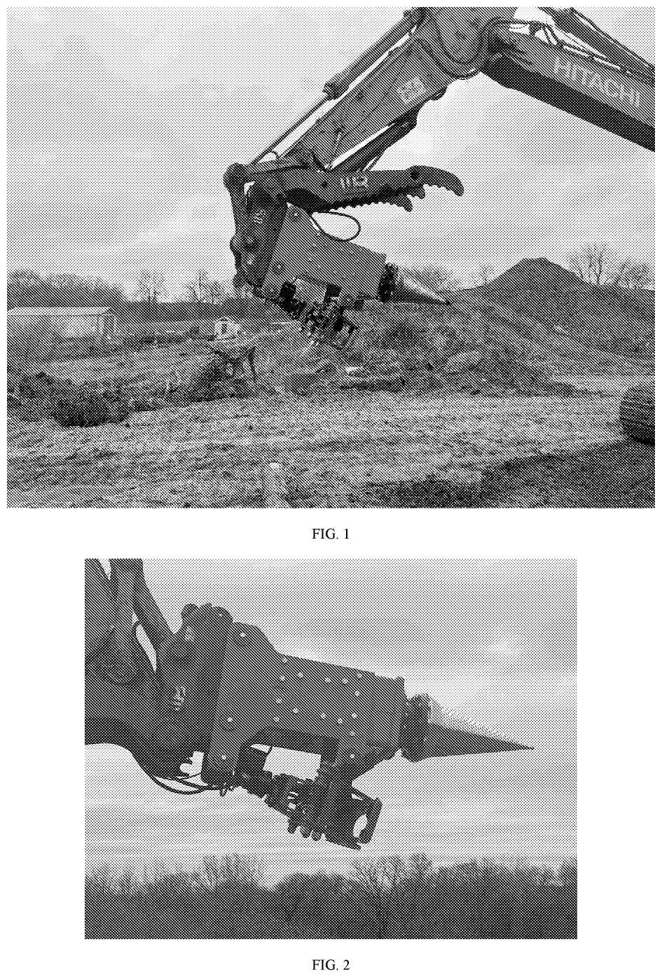

FIG. 1 shows an embodiment of a grapple-splitter apparatus of the present invention wherein an embodiment of the grapple is closed in a home position with an embodiment of the splitter pointing towards an excavator to which the apparatus is operatively coupled, the view being from the side of the apparatus. FIG. 2 shows the apparatus with the grapple closed in a home position with the splitter pointing away from the excavator.

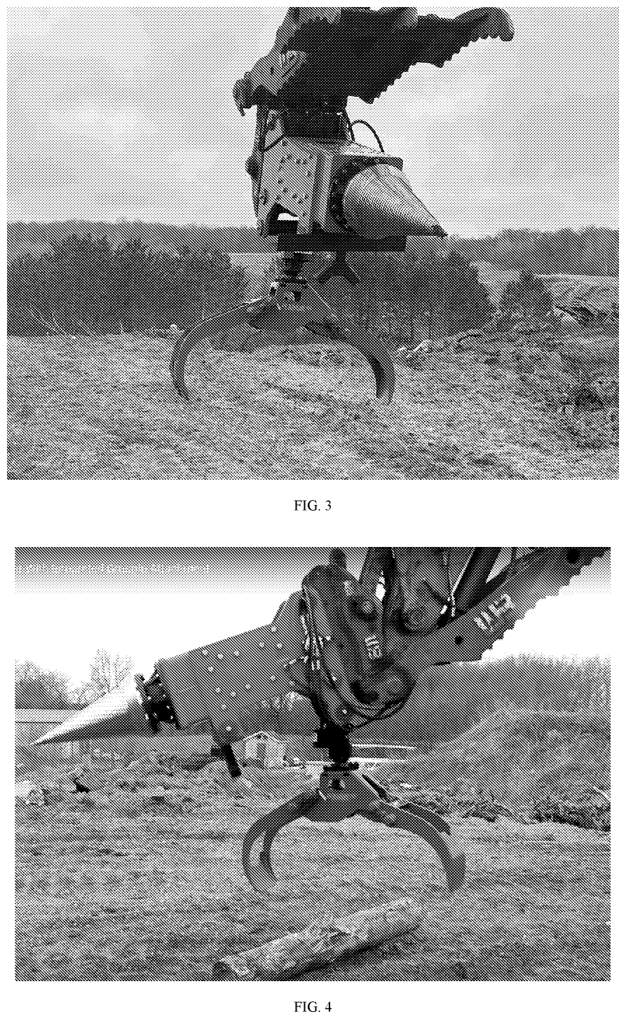

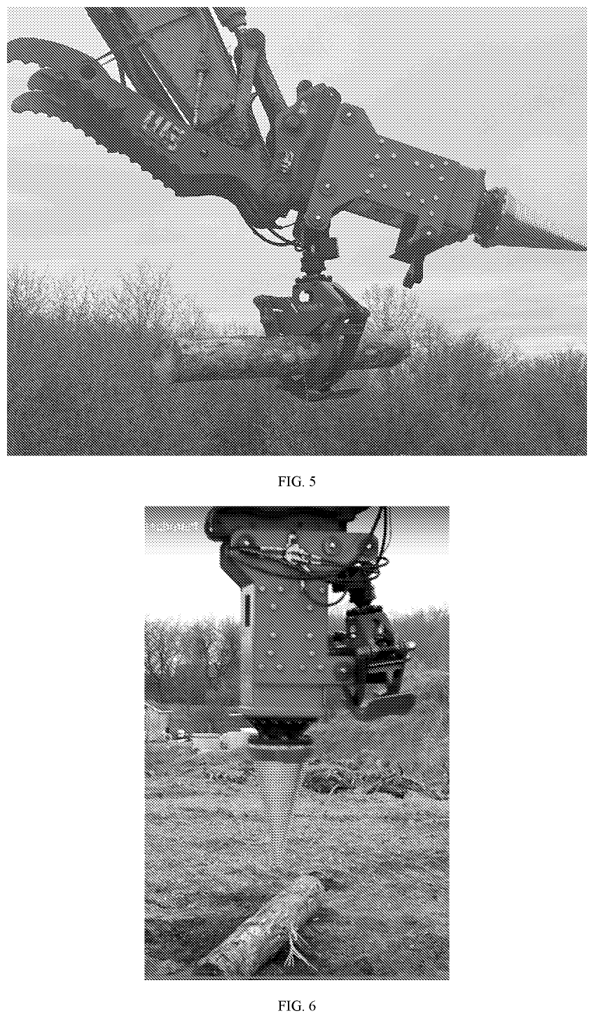

FIG. 3 shows the apparatus with the grapple open and the splitter is pointing towards the excavator, the view being in line with the excavator arm. FIG. 4 shows the apparatus with the grapple open and about to engage a log, the splitter pointing away from the excavator, the view being from the side of the apparatus. FIG. 5 shows the apparatus wherein the grapple has grasped and lifted the log in the process of moving the log.

FIG. 6 shows the apparatus wherein the grapple is closed and the splitter is in the process of engaging a log.

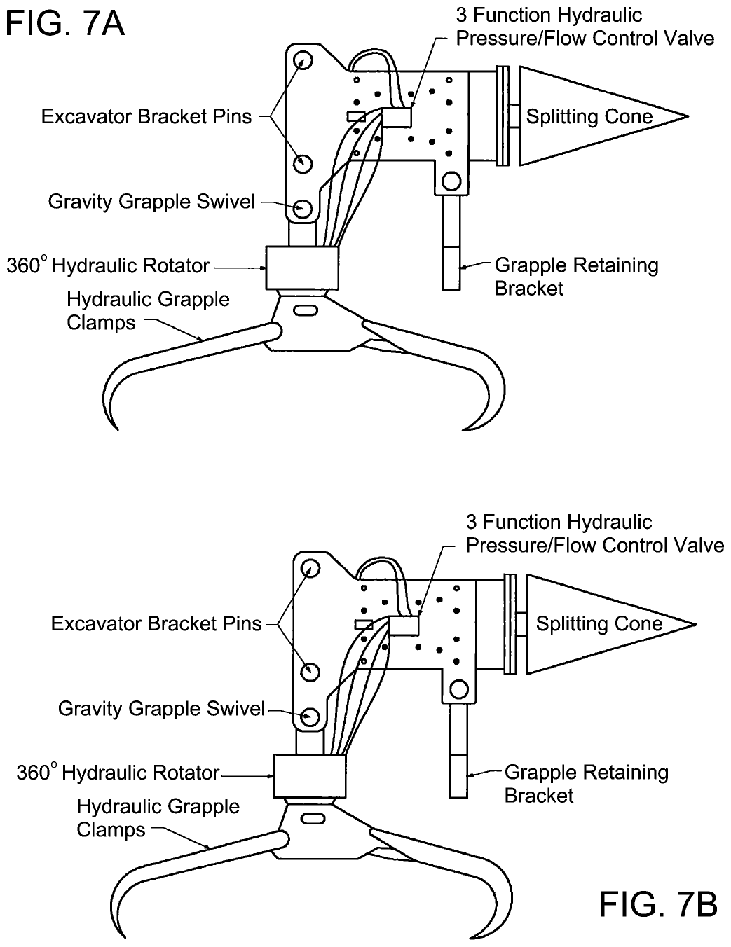

FIGS. 7 A/B is a diagrammatic illustration of an embodiment of the apparatus.

The apparatus has a Y-Shaped Bracket that the grapple grabs when the grapple is not in use. The bracket has a post member that is secured to a main frame of the splitter. This arrangement maintains the grapple safely stored out the way of the splitter.

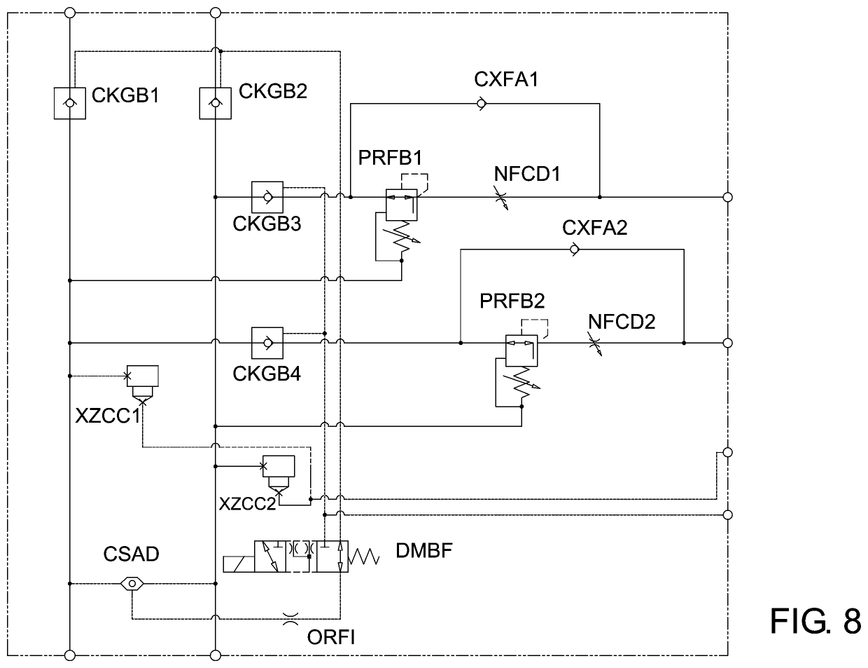

The apparatus has a unique electro-valve and manifold that controls and powers the splitter and grapple assemblies. The splitter utilizes hydraulic fluid pressurized relatively high at 5,000 pounds per square inch (psi) and at a flow rate of 50 gallons per minute (gpm). The grapple utilizes hydraulic fluid at a lower 2,000 psi and 20 gpm. The electro-valve reduces splitter fluid characteristics to the proper characteristics for the grapple. The hydraulic valve assembly is custom machined from a block of steel. The controller is push button type and is disposed in the excavator cab. FIG. 8 is a schematic diagram of an embodiment of a circuit that controls an embodiment of a hydraulic electro-valve, showing the functionality and connectivity between electrical components thereof.

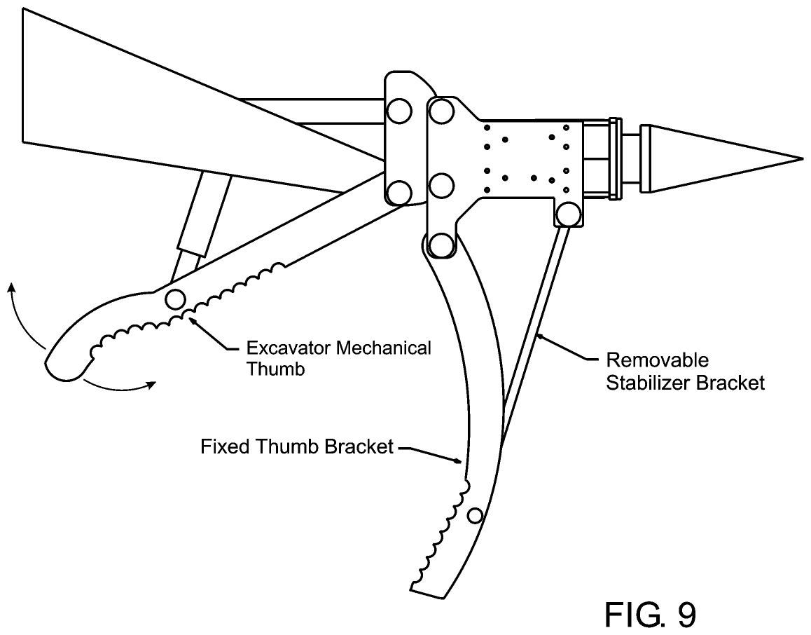

FIG. 9 shows an alternative embodiment of a combination splitter assembly and pickup assembly. The combination apparatus utilizes an existing excavator thumb in place of a grapple. An existing excavator thumb grapple provides basic functionality to move material using a single member. The thumb pinches the material between it and the bucket of the excavator. In the instant invention, the log splitter replaces the bucket on the excavator and the thumb cannot be used to pinch against the splitter. The apparatus of the invention adds a fixed thumb bracket to the splitter frame allowing the standard mechanical thumb of the excavator to pinch against the new thumb bracket and protecting the log splitter in the process.

A list of elements in the embodiments, shown interconnected in the drawings, of the invention is as follows:

| Element | Quantity | Model | Setting | Description |
|---|---|---|---|---|
| XZCC 1 and 2 | 2 | XZCCXXN | | Cavity Plug |
| PRFB 1 and 2 | 2 | PRFBLAN | 2000 psi | Pressure Reducing and Relieving |
| ORF1 | 1 | 280-039-039 | | ½ NPTF |
| NFCD 1 and 2 | 2 | NFCDLFN | | Needle |
| DMBF | 1 | DMBFXAN912 | | Solenoid Operated Directional |
| CXFA 1 and 2 | 2 | CXFAXCN | | Check |
| CSAD | 1 | CSADXXN | | Shuttle |
| CKGB 1, 2, 3, 4 | 4 | CKGBXCN | | Pilot to Open Check Valve |

Although the apparatus and methods of manufacture and use have been described in connection with the forestry field and logging industry, it can readily be appreciated that it is not limited solely to such field, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. An apparatus comprising all of the structural and functional elements disclosed in the specification.

2. A method comprising all of the steps disclosed in the specification.
